(19) United States
(12) Patent Application Publication
(10) Pub. No.: US 2024/0194876 A1
(43) Pub. Date: Jun. 13, 2024

(54) POSITIVE ELECTRODE ADDITIVE FOR A LITHIUM SECONDARY BATTERY, A METHOD OF MANUFACTURING SAME, AND A POSITIVE ELECTRODE FOR A LITHIUM SECONDARY BATTERY INCLUDING SAME

(71) Applicants: HYUNDAI MOTOR COMPANY, Seoul (KR); KIA CORPORATION, Seoul (KR); UNIVERSITY-INDUSTRY COOPERATION GROUP OF KYUNG HEE UNIVERSITY, Yongin-si (KR)

(72) Inventors: Da Bin Jang, Gwangju (KR); Sung Ho Ban, Hwaseong-si (KR); Sang Hun Lee, Paju-si (KR); Yong Hoon Kim, Daejeon (KR); Ha Eun Lee, Incheon (KR); Seung Min Oh, Incheon (KR); Chang Hoon Song, Seoul (KR); Sung Min Park, Hanam-si (KR); Hyo Bin Lee, Goheung-gun (KR); Tae Hee Kim, Yongin-si (KR); Min Sik Park, Suwon-si (KR)

(73) Assignees: HYUNDAI MOTOR COMPANY, Seoul (KR); KIA CORPORATION, Seoul (KR); UNIVERSITY-INDUSTRY COOPERATION GROUP OF KYUNG HEE UNIVERSITY, Yongin-si (KR)

(21) Appl. No.: 18/384,736

(22) Filed: Oct. 27, 2023

(30) Foreign Application Priority Data
Dec. 8, 2022 (KR) 10-2022-0170886

(51) Int. Cl. H01M 4/62; H01M 4/04; H01M 10/052

(52) U.S. Cl. CPC H01M 4/62; H01M 4/0471; H01M 10/052; H01M 2004/028

(57) ABSTRACT

A positive electrode additive for a lithium secondary battery can improve atmospheric stability. A method of manufacturing the same and a positive electrode for a lithium secondary battery includes the same. The positive electrode additive for a lithium secondary battery is used to manufacture the positive electrode for a lithium secondary battery and includes a lithium (Li)-based additive core and a coating layer of NbO_{X}C_{y} (0≤x≤2.5 and 0≤y≤1; where Nb=niobium, O=oxygen, C=carbon) formed on a surface of the additive core.

### CROSS REFERENCE TO RELATED APPLICATION

The present application claims priority to Korean Patent Application No. 10-2022-0170886 filed on Dec. 8, 2022, the entire contents of which are incorporated herein for all purposes by this reference.

### BACKGROUND

### Field of the Disclosure

The present disclosure relates to a positive electrode additive for a lithium secondary battery, a method of manufacturing the same, and a positive electrode for a lithium secondary battery including the same. More particularly, the present disclosure relates to a positive electrode additive for a lithium secondary battery, which is capable of improving atmospheric stability, a method of manufacturing the same, and a positive electrode for a lithium secondary battery including the same.

### Description of the Related Art

Secondary batteries are used as large-capacity power storage batteries for electric vehicles and battery power storage systems. Secondary batteries are also used as small and high-performance energy sources for portable electronic devices, such as mobile phones, camcorders, and notebook computers. With the aim of miniaturizing portable electronic devices and continuous use for a long time, there is a demand for a secondary battery capable of realizing a small size and a high capacity along with research on weight reduction of parts and low power consumption.

In particular, a lithium secondary battery, which is a typical secondary battery, has a higher energy density, a larger capacity per area, a lower self-discharge rate, and a longer lifetime than a nickel manganese battery or a nickel cadmium battery. In addition, since there is no memory effect, the lithium secondary battery has a characteristic of convenience of use and a long lifetime.

The lithium secondary battery generates electrical energy due to oxidation and reduction reactions when lithium ions are intercalated/deintercalated from a positive electrode and a negative electrode. The lithium secondary battery generates electrical energy in a state in which an electrolyte fills between the positive electrode and the negative electrode, which are made of an active material capable of intercalation and deintercalation of the lithium ions.

The lithium secondary battery is formed of a positive electrode material, an electrolyte, a separator, a negative electrode material, and the like. Maintaining a stable interface reaction between the components is very important to secure a long lifetime and reliability of the lithium secondary battery.

The positive electrode is manufactured by mixing a binder with a positive electrode active material and a conductive material. The negative electrode is manufactured by mixing the binder with a negative electrode active material and the conductive material. In addition, the positive and negative electrodes may be manufactured by further mixing various functional additives, which improve performance of the electrode and the cell.

Meanwhile, various graphite-based materials capable of intercalating and deintercalating lithium are used as negative electrode active materials for lithium secondary batteries. However, since a graphite-based material has a low theoretical capacity, i.e., 372 milliampere-hours per gram mass (mAh/g), it is difficult for the graphite-based material to implement a cell with a high energy density.

Thus, various studies have been recently conducted to apply silicon oxide or transition metal oxide, which can implement a high theoretical capacity, as a negative electrode active material. However, the negative electrode active material has a problem in that an initial charge loss of about 30% occurs after first charging due to a high irreversible characteristic during initial charging.

Meanwhile, in order to solve development limitation of the negative electrode active material, various studies on positive electrode additives applied to overcome irreversible capacity loss of a negative electrode have been conducted.

For example, there is a method of applying lithium nickel oxide (Li₂NiO₂) or lithium cuprate (Li₂CuO₂), which contains excess lithium as a positive electrode additive, to a positive electrode.

The positive electrode additive contains excess lithium, and lithium oxide remains on a surface of the positive electrode additive. The excess lithium included in the positive electrode additive or the lithium oxide remaining on the surface easily reacts with moisture or carbon dioxide in the air to form by-products, such as lithium carbonate (Li₂CO₃) and lithium hydroxide (LiOH), on the surface of the positive electrode additive. In addition, there is a problem in that the by-products generate gas through a side reaction with an electrolyte and act as a cause of degrading an electrochemical characteristic of a battery.

The foregoing is intended merely to aid in understanding the background of the present disclosure. The foregoing is not intended to mean that the present disclosure falls within the purview of the related art that is already known to those having ordinary skill in the art.

### SUMMARY

Accordingly, the present disclosure has been made keeping in mind the above problems occurring in the related art. The present disclosure is intended to propose a positive electrode additive for a lithium secondary battery. The additive is capable of suppressing formation of by-products, such as lithium carbonate (Li₂CO₃) and lithium hydroxide (LiOH), on a surface of the positive electrode additive when left in the air and capable of improving atmospheric stability. Thus, an excellent electrochemical characteristic may be maintained. The present disclosure is also intended to propose a method of manufacturing the same and a positive electrode for a lithium secondary battery including the same.

The technical problems to be solved by the present disclosure are not limited to the above-mentioned technical problems. Other technical problems, which are not mentioned herein, should be more clearly understood by those having ordinary skill in the art to which the present disclosure pertains from the following description.

According to one aspect, a positive electrode additive is provided for a lithium secondary battery. The additive is used to prepare a positive electrode for a lithium secondary battery and includes a Li-based additive core and a coating layer of NbO_{X}C_{y} (0≤x≤2.5 and 0≤y≤1) formed on a surface of the additive core (Li=lithium, Nb=niobium, O=oxygen, C=carbon).

The additive core may be formed of Li₂MO₂ (M=Ni, Cu; Ni=nickel, Cu=copper).

The coating layer may range from 1 to 10 wt % based on 100 wt % of the additive core.

According to another aspect, a method of manufacturing a positive electrode additive for a lithium secondary battery is provided. The method is used to prepare a positive electrode for a lithium secondary battery and includes a core preparation operation of preparing a Li-based additive core. The method also includes a coating solution preparation operation of preparing a coating solution to form a coating layer composed of NbO_{X}C_{y} (0≤x≤2.5 and 0≤y≤1). The method also includes a coating operation of coating a surface of the additive core with the coating solution and forming a coating layer.

In the core preparation operation, lithium oxide (Li₂O) may be reacted with a MO precursor (M=Ni, Cu) to prepare a powdered additive core of Li₂MO₂ (M=Ni, Cu).

The core preparation operation may include a core pelletization process of mixing and pelletizing Li₂O and the MO precursors (M=Ni, Cu). The core preparation operation may also include a core sintering process of heating and sintering the pelletized core material in an inert atmosphere to obtain the additive core.

In the coating solution preparation operation, the coating solution may be prepared by dispersing niobium ethoxide (Nb(OC₂H₅)₅) and urea (CH₄N₂O) at the same molar ratio in a solvent.

The coating operation may include a dispersion operation of dispersing the additive core in the prepared coating solution. The coating operation may also include a reaction operation of generating a reactant forming the coating layer on the surface of the additive core by stirring and reacting the additive core dispersed in the solvent with Nb(OC₂H₅)₅ and CH₄N₂O. The coating operation may also include a drying process of drying the solvent in which the reactant is generated in an inert atmosphere. The coating operation may also include a sintering process of sintering the dried reactant and producing an additive in the form of a powder.

In the reaction operation, the additive core dispersed in the solvent, Nb(OC₂H₅)₅, and CH₄N₂O may be stirred at 300 to 400 rpm for 1 to 2 hours at room temperature, and the solvent may be evaporated while reacting with Nb(OC₂H₅)₅ and CH₄N₂O on the surface of the additive core.

In the drying operation, the additive core having the reactant formed on the surface thereof may be dried at a temperature ranging from 110 to 130° C. for time period ranging from 11 to 13 hours in a vacuum oven.

In the sintering operation, the coating layer may be formed on the surface of the additive core by performing heat treatment on the additive core having the reactant generated on the surface thereof at a temperature ranging from 250 to 350° C. for 3 to 5 hours in a sintering furnace in an argon (Ar) atmosphere.

According to still another aspect, a positive electrode for a lithium secondary battery includes a Li-based additive core and a positive electrode additive including a coating layer of NbO_{X}C_{y} (0≤x≤2.5 and 0≤y≤1) formed on a surface of the additive core.

In addition, the positive electrode for a lithium secondary battery may further include a conductive material and a binder.

According to still another aspect, a lithium secondary battery includes a Li-based additive core and a positive electrode including a positive electrode additive having a coating layer of NbO_{X}C_{y} (0≤x≤2.5 and 0≤y≤1) formed on a surface of the additive core.

In addition, the lithium secondary battery may further include a negative electrode containing a negative electrode active material and include electrolytes.

### BRIEF DESCRIPTION OF THE DRAWINGS

The above and other objects, features, and other advantages of the present disclosure should be more clearly understood from the following detailed description when taken in conjunction with the accompanying drawings, in which:

FIG. 1 is a diagram illustrating a positive electrode additive for a lithium secondary battery according to one embodiment of the present disclosure;

FIGS. 2A-2C are diagrams illustrating Raman analysis results of comparative examples and examples;

FIGS. 3A and 3B are diagrams illustrating X-ray diffraction (XRD) analysis results of the comparative examples and the examples;

FIG. 4 is a diagram illustrating scanning electron microscope (SEM) images and niobium (Nb) element distributions through energy dispersive spectroscopy (EDS) analysis of the comparative examples and the examples;

FIGS. 5A-5F are diagrams illustrating X-ray photoelectron spectroscopy (XPS) analysis results of the comparative examples and the examples;

FIG. 6 is a diagram illustrating electrochemical evaluation results of the comparative examples and the examples;

FIGS. 7A-7E are graphs showing evaluation results of air exposure over time at relative humidity of 40% in the comparative examples and the examples;

FIG. 8A is a diagram illustrating SEM images and Nb element distributions through EDS analysis of the comparative examples and the examples according to a change in manufacturing method;

FIG. 8B is a diagram illustrating the electrochemical evaluation results of comparative examples and examples according to changes in the manufacturing method;

FIG. 9 is a diagram illustrating electrochemical evaluation results of the comparative examples and the examples according to a change in heat treatment temperature; and

FIGS. 10A and 10B are diagrams illustrating XRD analysis results of the comparative examples and the examples according to a change in heat treatment temperature.

### DETAILED DESCRIPTION

Hereinafter, embodiments disclosed in the present specification are described in detail with reference to the accompanying drawings. The same reference numerals are given to the same or similar components throughout the drawings, and a repetitive description thereof has been omitted.

In the following description of the present specification, where a detailed description of a known related art has been determined to obscure the gist of the present specification, the detailed description thereof has been omitted herein. In addition, the accompanying drawings are merely to aid in understanding the embodiments disclosed in the present specification. The technical spirit disclosed in the present specification is not limited by the accompanying drawings. It should be understood that all modifications, equivalents, and substitutes are included in the spirit and scope of the present disclosure.

Terms including ordinal numbers, such as first, second, and the like, used herein may be used to describe various components, but the various components are not limited by these terms. The terms are used only for the purpose of distinguishing one component from another component.

Unless the context clearly dictates otherwise, the singular form includes the plural form.

In the present specification, the terms “comprising,” “having,” or the like, and variations thereof, are used to specify that a feature, a number, a step, an operation, a component, an element, or a combination thereof described herein exists. These terms do not preclude the presence or addition of one or more other features, numbers, steps, operations, components, elements, or combinations thereof.

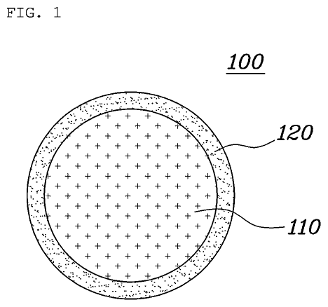

FIG. 1 is a diagram illustrating a positive electrode additive for a lithium secondary battery according to one embodiment of the present disclosure.

A positive electrode additive 100 for a lithium secondary battery according to one embodiment of the present disclosure is a positive electrode additive used to manufacture a positive electrode for a lithium secondary battery. The positive electrode additive 100 includes a Li-based additive core 110 (Li=lithium) and a coating layer 120, which has an electron conductive function and is formed on a surface of the additive core 110. In this case, the positive electrode additive may be applied as a positive electrode active material forming a positive electrode.

In this case, the Li-based additive core 110 may be made of Li₂MO₂ (M=Ni, Cu, where Ni=nickel and Cu=copper)).

Lithium nickel oxide (Li₂NiO₂) or lithium cuprate (Li₂CuO₂) used as the additive core 110 in the present embodiment is an additive material applied to overcome an irreversible capacity loss of a negative electrode. For example, in the present embodiment, it may be desirable to apply Li₂NiO₂ as the additive core 110.

In addition, the coating layer 120 may be made of NbO_{X}C_{y} (0≤x≤2.5 and 0≤y≤1; where Nb=niobium, 0=oxygen, C=carbon)).

For example, in the present embodiment, the coating layer 120 is a material formed by reacting urea (CH₄N₂₀) with niobium ethoxide (Nb(OC₂H₅)₅) provided as a coating material precursor.

Meanwhile, an amount of the formed coating layer 120 may be at a level ranging from 1 to 10 wt % based on 100 wt % of the additive core 110.

When the amount of the formed coating layer 120 is less than 1 wt %, it is not possible to fully expect an effect of suppressing degradation of atmospheric stability and an electrochemical characteristic due to the formation of the coating layer 120. When the amount of the formed coating layer 120 exceeds 10 wt %, a thickness of the coating layer 120 becomes so large that an effect of adding the positive electrode additive may be degraded.

Meanwhile, the positive electrode for a lithium secondary battery further includes a conductive material and a binder together with the above-described positive electrode additive.

In addition, the lithium secondary battery includes an electrolyte and a negative electrode including a negative electrode active material, in addition to the above-described positive electrode.

A method of manufacturing the positive electrode additive formed as described above is described.

The method of manufacturing the positive electrode additive for a lithium secondary battery according to one embodiment of the present disclosure broadly includes a core preparation operation of preparing a Li-based additive core. The method also broadly includes a coating solution preparation operating of preparing a coating solution for forming a coating layer composed of NbO_{X}C_{y} (0≤x≤2.5 and 0≤y≤1). The method also broadly includes a coating operation of forming a coating layer by coating a surface of the additive core with the coating solution.

The core preparation operation is an operation of preparing the Li-based additive core and includes reacting lithium oxide (Li₂O) and an MO precursor (M=Ni, Cu) to prepare a powdered additive core of Li₂MO₂ (M=Ni, Cu).

In this case, the core preparation operation includes a core pelletization process of mixing Li₂O with the MO precursor (M=Ni, Cu) and pelletizing the mixture. The core preparation operation also includes a core sintering process of heating and sintering the pelletized core material in an inert atmosphere and obtaining an additive core.

Additionally, the core pelletization process includes to mix Li₂O and the MO precursor (M=Ni, Cu) in a dry manner and then pelletize the mixture.

In addition, in the core sintering process, the pelletized core material is loaded in a sintering furnace, an atmosphere temperature of the sintering furnace is raised 700° C. by 5° C. per minute, and the pelletized core material is maintained at a corresponding temperature for 17 hours and sintered. Hereafter, the sintered core product is cooled and pulverized to obtain a powdered additive core.

The coating solution preparation operation is an operation of preparing a coating solution for forming a functional coating layer on the surface of the additive core. The coating solution is prepared by dispersing urea (CH₄N₂O) and niobium ethoxide (Nb(OC₂H₅)₅), which is provided as a coating material precursors, in anhydrous ethanol used as a solvent at the same molar ratio.

In addition, the coating operation is an operation of forming a coating layer on a surface of the prepared additive core. The coating operation includes a dispersion process of dispersing the additive core in the prepared coating solution.

The coating operation also includes a reaction process of generating a reactant for forming a coating layer on the surface of the additive core by stirring and reacting the additive core dispersed in the solvent with Nb(OC₂H₅)₅ and CH₄N₂O. The coating operation also includes a drying process of drying the solvent in which the reactant is generated in an inert atmosphere. The coating operation also includes sintering process of sintering the dried reactant to produce an additive in the form of a powder.

Additionally, the dispersion process includes a process of adding and dispersing the prepared additive core in the coating solution, which is a solvent in which Nb(OC₂H₅)₅ and CH₄N₂O are dispersed.

The reaction process is a process of stirring the additive core, Nb (OC₂H₅)₅, and CH₄N₂O, which are dispersed in the solvent at room temperature ranging from 1 to 2 hours at a revolutions per minute (rpm) ranging from 300 to 400 rpm. The reaction process is also a process of evaporating the solvent while reacting Nb (OC₂H₅) s with CH₄N₂O on the surface of the additive core.

In addition, the drying process is a process of evaporating the anhydrous ethanol, which is a solvent remaining on the surface of the additive core. The drying process includes drying the additive core having the surface on which a reactant is formed in a vacuum oven at a temperature ranging from 110 to 130° C. for period of time ranging from 11 to 13 hours.

The sintering process is a process of forming a coating layer on the surface of the additive core by performing heat treatment on the dried additive core having the surface on which the reactant is generated in a sintering furnace in an argon (Ar) atmosphere at a temperature ranging from 250 to 350° C. for a period of time ranging from 3 to 5 hours. Thereafter, the sintered product of the positive electrode additive is cooled at room temperature and then pulverized to obtain a powdered positive electrode additive.

Next, the present disclosure is described through comparative examples and examples.

In Comparative Example 1, an additive core on which the coating layer was not formed was used as a positive electrode additive.

In addition, in Comparative Example 2, only a material forming the coating layer without the additive core was used as the positive electrode additive.

In addition, in Examples 1-4, the positive electrode additive prepared according to one embodiment of the present disclosure and having the coating layer formed on the surface of the additive core was used. In this case, in Examples 1-4, the coating layer was formed by adjusting the amount of the coating layers to 1 wt %, 3 wt %, 5 wt %, and 10 wt % based on 100 wt % of the additive core.

The preparation of the comparative examples and the examples is as follows.

### Comparative Example 1

Li₂O and a nickel oxide (NiO) precursor were mixed to synthesize the additive core, pelletized, and maintained at a temperature raised to 700° C. by 5° C. per minute for 17 hours in a sintering furnace. Then, the sintered product was cooled and pulverized to obtain a powdered additive core of Comparative Example 1.

### Comparative Example 2

In order to synthesize a material forming the coating layer, Nb(OC₂H₅)₅ and CH₄N₂O were dispersed in the same molar ratio in an anhydrous ethanol solvent and then stirred for 5 hours, the anhydrous ethanol was removed, and Nb(OC₂H₅)₅ and CH₄N₂O were dried in a glove box in an Ar atmosphere for 12 hours. Thereafter, the temperature was raised to 300° C. by 5° C. per minute, Nb(OC₂H₅)₅ and CH₄N₂O were maintained at the temperature of 300° C. for 4 hours.

Then the sintered product was cooled and pulverized to obtain a powdered material forming the coating layer of Comparative Example 2.

### Example 1

Nb(OC₂H₅)₅ and CH₄N₂O were dispersed in an anhydrous ethanol solvent at the same molar ratio, and the additive core prepared in Comparative Example 1 was dispersed together with Nb(OC₂H₅)₅ and CH₄N₂O and then stirred at 400 rpm for 1 hour. In addition, in order to remove anhydrous ethanol, which is a solvent, the stirred product was dried in a vacuum oven at a temperature of 120° C. for 12 hours. Then, a temperature of a sintered furnace was raised to 300° C. by 5° C. per minute and maintained at the raised temperature for 4 hours. Thereafter, the sintered product was cooled and pulverized to obtain a positive electrode additive having a surface on which the coating layer is formed. In this case, amounts of Nb(OC₂H₅)₅ and CH₄N₂O and an amount of the additive core were adjusted so that an amount of the coating layer become 1 wt % based on 100 wt % of the additive core.

### Example 2

A positive electrode additive of Example 2 was obtained in the same manner as in Example 1. However, the coating layer was formed at a level of 3 wt %.

### Example 3

A positive electrode additive of Example 3 was obtained in the same manner as in Example 1. However, the coating layer was formed at a level of 5 wt %.

### Example 4

A positive electrode additive of Example 4 was obtained in the same manner as in Example 1. However, the coating layer was formed at a level of 10 wt %.

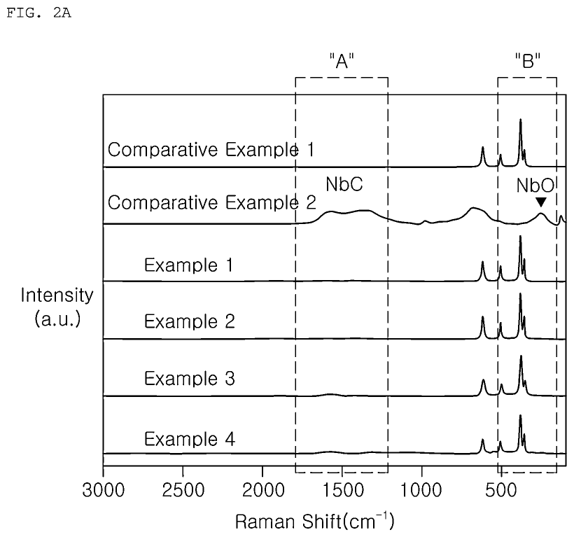

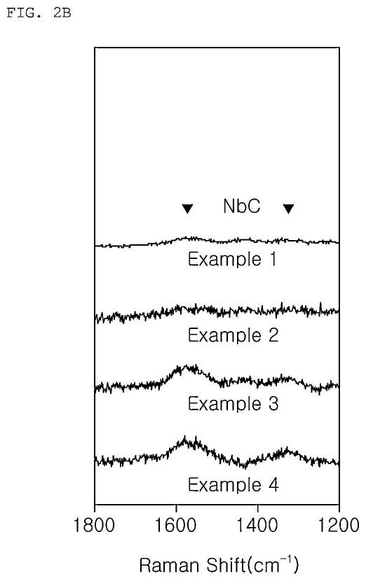

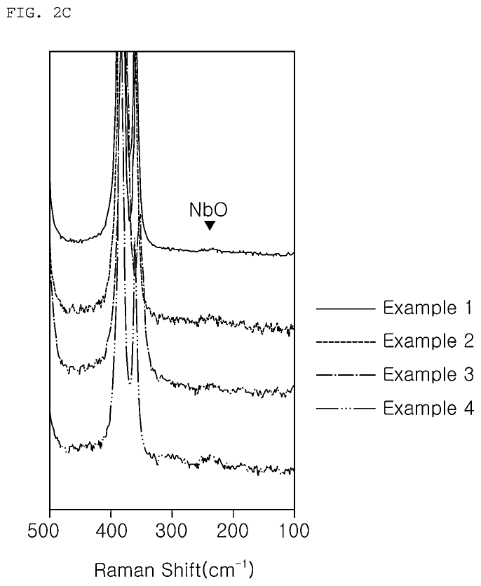

Raman analysis was performed on Comparative Examples 1 and 2 and Examples 1-4, which were prepared as described above, and the results were shown in FIGS. 2A-2C. FIG. 2B is an enlarged diagram illustrating dotted line box region “A” in FIG. 2A. FIG. 2C is an enlarged diagram illustrating dotted line box region “B” in FIG. 2A.

As can be seen from FIGS. 2A-2C, it was confirmed that bonding structures of Comparative Example 1 and Comparative Example 2 coexist in the analysis results of Examples 1-4.

In addition, it was confirmed that peaks gradually were increased from Example 1 to Example 4 as the amount of the coating layer is increased.

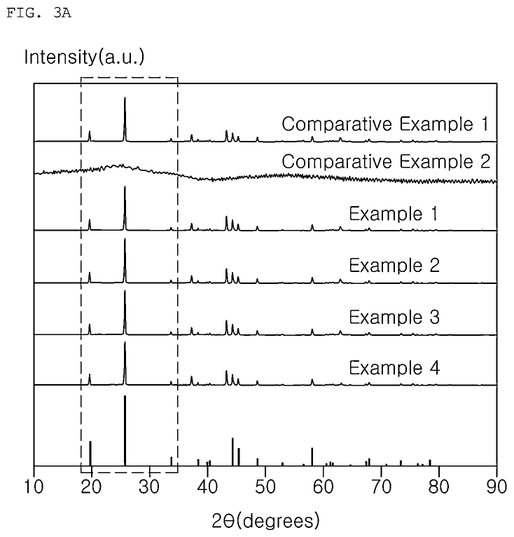

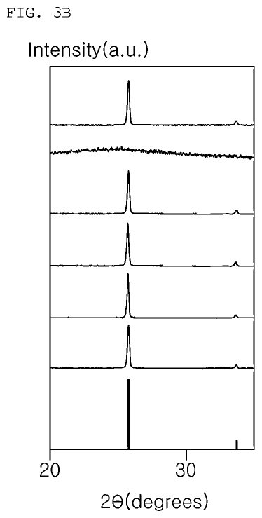

In addition, X-ray diffraction analysis was performed on prepared Comparative Examples 1 and 2 and Examples 1-4, and the results were shown in FIGS. 3A and 3B. In this case, FIG. 3B is an enlarged diagram illustrating a dotted line box region of FIG. 3A.

As can be seen from FIGS. 3A and 3B, it was confirmed that Comparative Example 1 had the existing crystal structure of Li₂NiO₂ (Immm, orthorhombic), and Comparative Example 2 had an amorphous phase.

In addition, it was confirmed that all X-ray diffraction (XRD) analysis results of Examples 1-4 were the same as that of Comparative Example 1 and additional impurities and secondary phases were not formed.

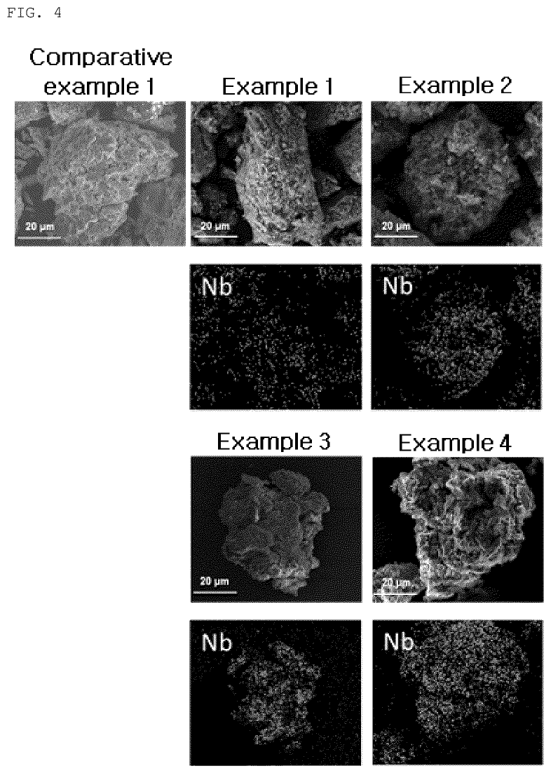

In addition, photographs of measured results of scanning electron microscopy (SEM) and measured results of Nb element distributions through energy dispersive spectroscopy (EDS) analysis for prepared Comparative Examples 1 and 2 and Examples 1-4 are shown in FIG. 4.

As can be seen from FIG. 4, it was confirmed that the coating layers were formed on particle surfaces of the positive electrode additives prepared in Examples 1-4, and it was confirmed that Nb elements were uniformly distributed through EDS mapping. In addition, it was confirmed that a detected amount of Nb element was gradually increased from Example 1 to Example 4 according to an increase in the amount of the coating layer.

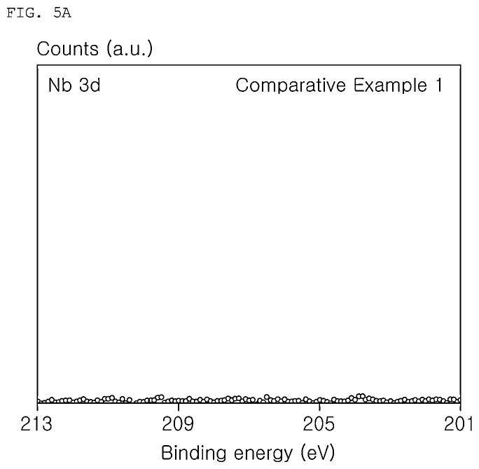

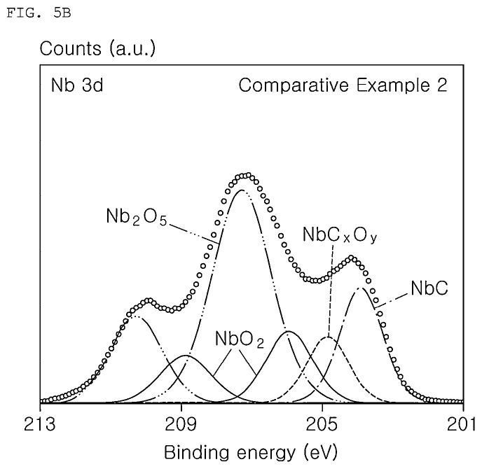

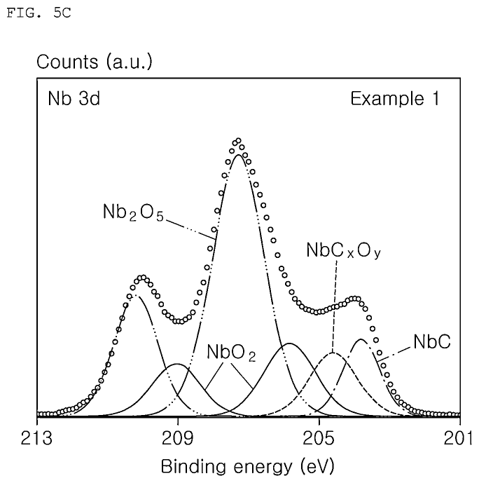

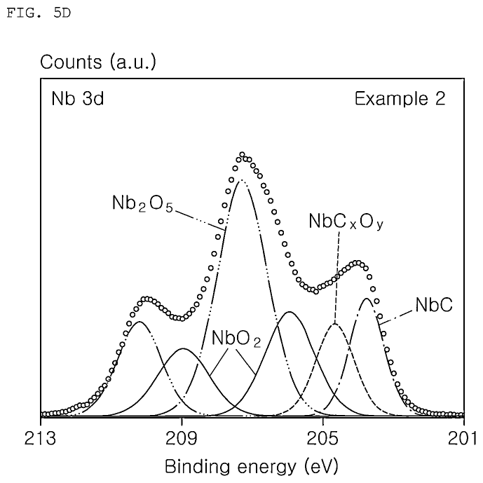

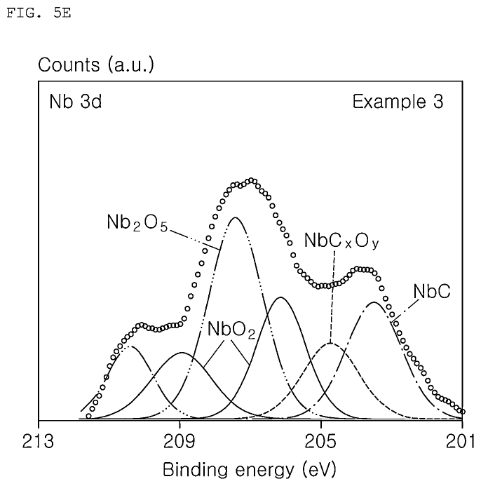

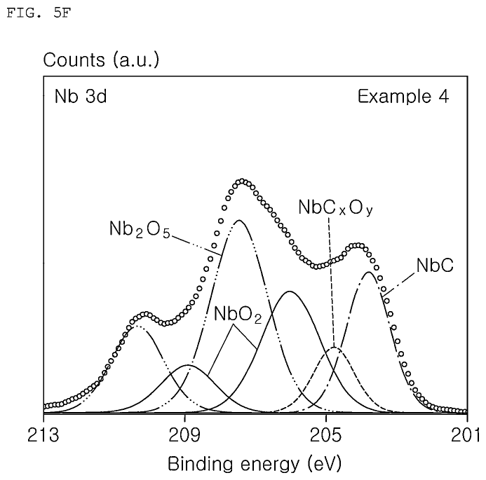

In addition, X-ray photoelectron spectroscopy (XPS) analysis was performed on prepared Comparative Examples 1 and 2 and Examples 1-4, and the results were shown in FIGS. 5A-5F.

As can be seen from FIGS. 5A-5F, it was confirmed that NbO_{X}C_{y} phases were formed on the surfaces of the positive electrode additives of Examples 1-4 through Comparative Examples 1 and 2 and Examples 1-4.

In particular, through the results of XPS analysis, it was confirmed that binding energy of the NbO_{X}C_{y} phase was present between 206.1 eV and 203.5 eV.

Next, electrodes were manufactured using prepared Comparative Examples 1 and 2 and Examples 1-4, and then coin cells were manufactured using the electrodes. Therefore, an electrochemical evaluation was performed on each of the manufactured coin cells through a charge/discharge test.

First, positive electrodes were manufactured prepared according to prepared Comparative Examples 1 and 2 and Examples 1-4.

In this case, the prepared positive electrode additive was used as a positive electrode active material. A carbon black conductive material, a carbon-based additive, and polyvinylidene fluoride (PVdF) were mixed with an N-methyl pyrrolidone (NMP) solvent at a weight ratio of 93:3:1:3 to prepare a positive electrode slurry. Then, aluminum foil was coated with the positive electrode slurry with a thickness of 50 μm and then dried and roll-pressed. A positive electrode was prepared by drying the aluminum foil at a temperature of 120° C. for 12 hours in a vacuum oven.

In addition, the prepared electrode was used, a solution in which one mole of LiPF₆ was dissolved in a solvent was used as an electrolyte, and then the conventional coin cell was prepared. In the solvent, ethylene carbonate (EC) and ethyl methyl carbonate (EMC) were mixed at a volume ratio of 1:2.

Then, a charging/discharging test, in which a voltage of charging and discharging was set to the range of 2.5 to 4.3 V, was performed on the prepared battery at 0.2 C/0.2 C, where 1.0 C=320 milliampere-hours per gram mass (mAh/g).

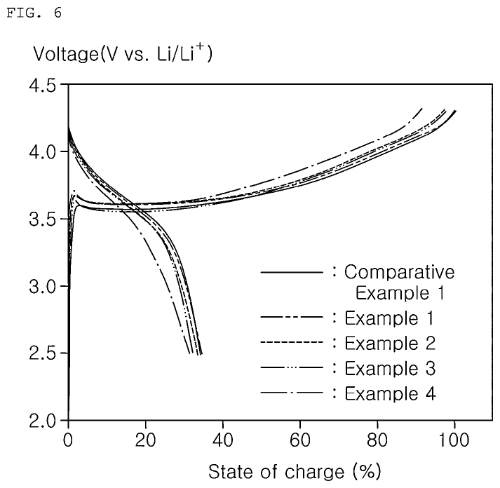

In addition, the test results are shown in the following Table 1 and FIG. 6.

TABLE 1

| Items | Charging (%) | Discharging (%) |
|---|---|---|
| Comparative Example 1 | 100 | 34.2 |
| Example 1 | 100.2 | 34.5 |
| Example 2 | 97.1 | 33.4 |
| Example 3 | 97.7 | 32.3 |
| Example 4 | 90.9 | 31.4 |

As can be seen from Table 1 and FIG. 6, it was confirmed that, as the amount of the coating layer was increased, an initial charging capacity was decreased, whereas a moisture shielding effect was improved. Particularly, in Example 3, in which the amount of the coating layer was 5 wt %, a meaningful moisture shielding effect was confirmed.

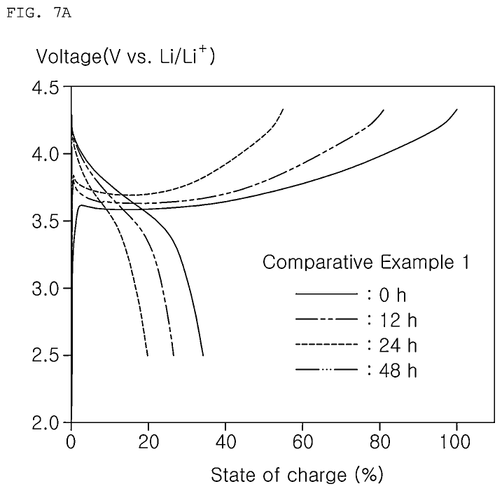

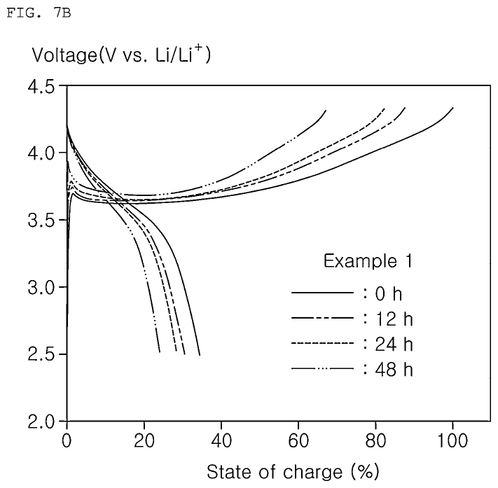

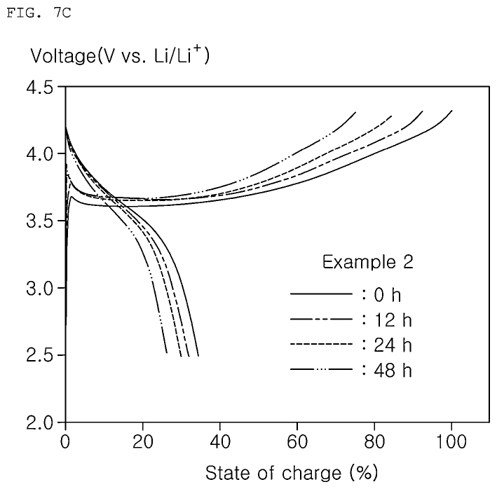

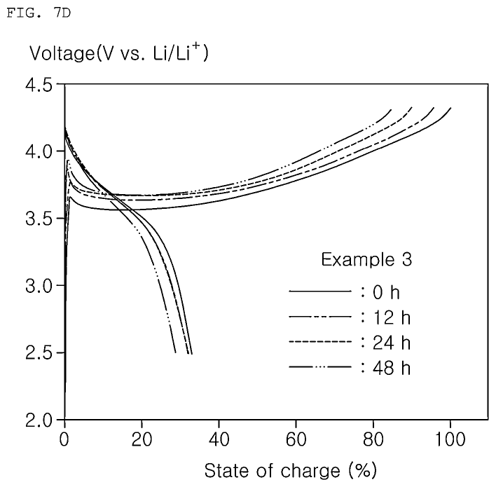

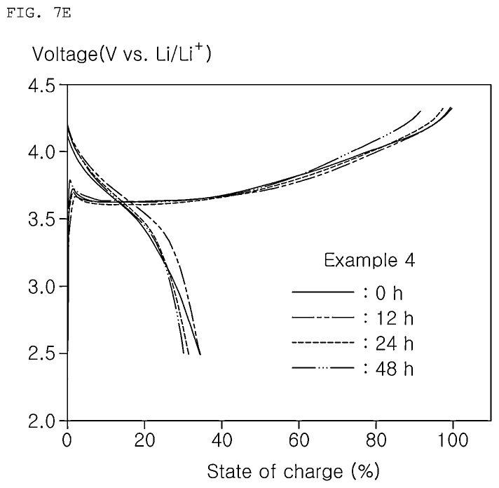

Next, the coin cells manufactured according to Comparative Examples 1 and 2 and Examples 1-4 were evaluated for air exposure over time at relative humidity of 40%, and the results are shown in the following Table 2 and FIGS. 7A-7E.

TABLE 2

| Items | | 0 h | 12 h | 24 h | 48 h |
|---|---|---|---|---|---|
| Comparative | Charging (%) | 100 | 81.0 | 54.9 | — |
| Example 1 | Discharging (%) | 34.2 | 26.6 | 19.8 | — |
| Example 1 | Charging (%) | 100.0 | 87.7 | 82.4 | 67.5 |
| | Discharging (%) | 34.5 | 30.6 | 28.6 | 24.2 |
| Example 2 | Charging (%) | 100 | 92.6 | 85.1 | 75.2 |
| | Discharging (%) | 34.4 | 31.8 | 29.8 | 26.2 |
| Example 3 | Charging (%) | 100 | 95.7 | 90.0 | 85.0 |
| | Discharging (%) | 33.0 | 32.0 | 32.2 | 28.8 |
| Example 4 | Charging (%) | 100 | 99.7 | 97.9 | 92.5 |
| | Discharging (%) | 34.5 | 34.5 | 31.6 | 30.4 |

As can be seen from Table 2 and FIGS. 7A-7E, in Comparative Example 1, it was confirmed that a capacity retention rate was about 81% after the exposure for 12 hours. Also, an internal short-circuit of the cell was induced in the evaluation after the exposure for 48 hours.

In addition, in Example 1, it was confirmed that a capacity retention rate was about 87.7% after the exposure for 12 hours and that the capacity retention rate of about 67.5% was maintained even after the exposure for 48 hours.

In addition, even in Examples 2-4, it was confirmed that capacity retention rates were about 92.6%, 95.7%, and 99.7% after the exposure for 12 hours and that the capacity retention rates of 75.2%, 85.0%, and 92.5% were maintained even after the exposure for 48 hours.

Next, a test was performed to compare states of the coating layers according to a change of the manufacturing method of forming a coating layer.

To this end, Comparative Example 1 and Example 2 were targeted. The surface of the additive core was coated with Nb(OC₂H₅)₅ and CH₄N₂O provided as coating material precursors applied in Example 2 in a dry process to prepare a control group (dry process).

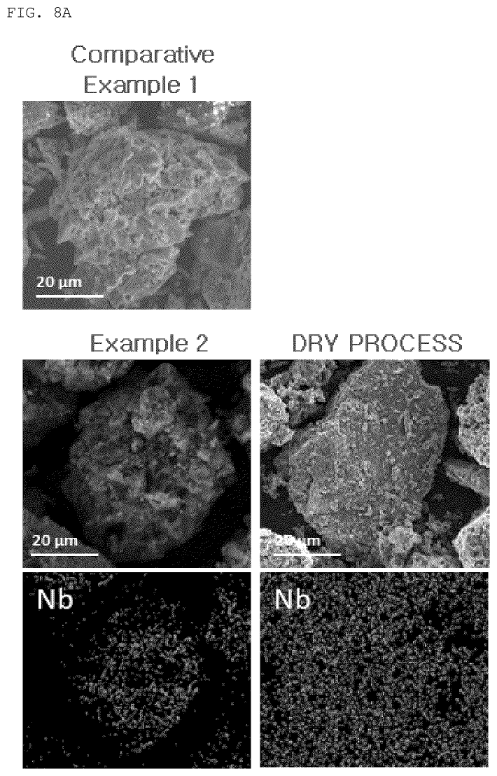

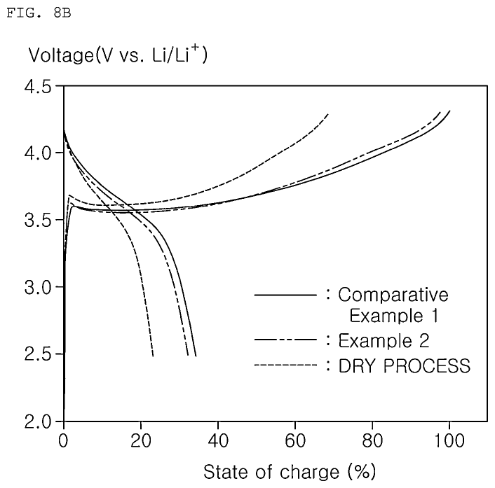

In addition, photographs of measured results of SEM and measured results of Nb element distributions through EDS analysis for prepared Comparative Example 1 and Example 2 and the control group (dry process) were shown in FIG. 8A.

In addition, a charge/discharge test was performed on the coin cells manufactured according to prepared Comparative Example 1 and Example 2 and the control group (dry process), and the results are shown in FIG. 8B.

As can be seen from FIGS. 8A and 8B, in the case of the dry process, which is a control group compared to Example 2, which is a wet process, it was confirmed that it was difficult to perform fine powder control and secure uniformity of the coating layer so that the initial charge capacity was relatively reduced.

Next, a test was performed to confirm a change in electrochemical characteristics according to a change in heat treatment temperature during the sintering process.

In this case, the test was performed at a heat treatment temperature of 300° C. during the sintering process in Comparative Example 1 and Example 2. The test was performed by changing the heat treatment temperature to 200° C., 400° C., and 500° C. in Comparative Examples 3-5.

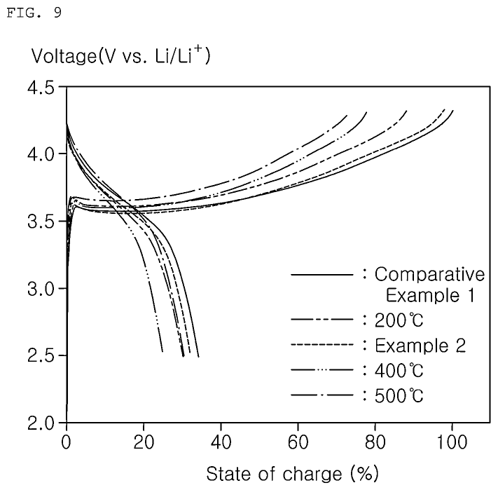

A charging/discharging test was performed on the coin cells manufactured according to Comparative Example 1, Example 2, and Comparative Examples 3-5, and the results are shown in the following Table 3 and FIG. 9.

TABLE 3

| Items | Charging (%) | Discharging (%) |
|---|---|---|
| Comparative Example 1 | 100 | 34.2 |
| Comparative Example 3 | 88.0 | 30.2 |
| (200° C.) | | |
| Example 2 | 97.7 | 32.2 |
| Comparative Example 4 | 77.9 | 25.1 |
| (400° C.) | | |
| Comparative Example 5 | 73.3 | 30.3 |
| (500° C.) | | |

As can be seen from Table 3 and FIG. 9, it was confirmed that the initial charge capacity of Example 2 was superior to those of Comparative Examples 3-5.

Accordingly, it was confirmed that a charging capacity deviation occurred according to the heat treatment temperature during the sintering process.

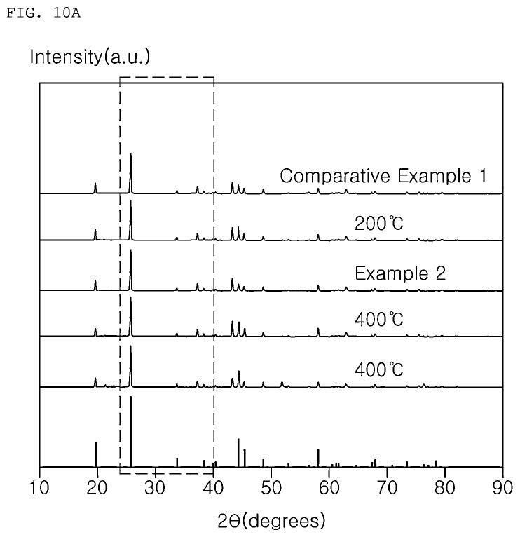

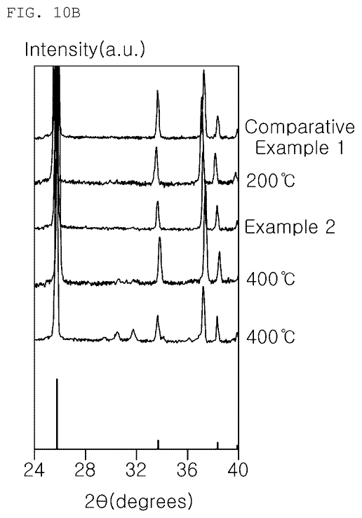

In addition, XRD analysis was performed on Comparative Example 1, Example 2, and Comparative Examples 3-5, and the results were shown in FIGS. 10A and 10B. In this case, FIG. 10B is an enlarged diagram illustrating a dotted line box region of FIG. 10A.

As can be seen from FIGS. 10A and 10B, it can be confirmed that, as the heat treatment temperature during the sintering process was increased, a Li₂CO₃ phase, which is an impurity due to a carbon thermal reaction, was increased, and thus a capacity decrease exhibited.

Accordingly, it was confirmed that maintaining the heat treatment temperature ranging from 250 to 350° C. during the sintering process, e.g., 300° C., is desirable to maintain an excellent initial charge capacity.

In accordance with the present disclosure, a coating layer having electron conductivity is formed on a surface of a positive electrode additive so that it is possible to expect an effect of reducing formation of impurities, such as Li₂CO₃ and LiOH, and suppressing degradation of atmospheric stability and electrochemical characteristics.

Although the present disclosure has been described with reference to the accompanying drawings and the above-described embodiments, the present disclosure is not limited thereto and is instead limited by the appended claims. Therefore, modifications and alternations to the embodiments of the present disclosure can be devised by those having ordinary skill in the art without departing from the scope of the technical spirit of the appended claims.

What is claimed is:

1. A positive electrode additive, which is used to prepare a positive electrode for a lithium secondary battery, the positive electrode additive comprising:
a lithium (Li)-based additive core; and
a coating layer of NbO_{X}C_{y} (0≤x≤2.5 and 0≤y≤1; where Nb=niobium, O=oxygen, C=carbon) formed on a surface of the additive core.

2. The positive electrode additive of claim 1, wherein the additive core is formed of Li₂MO₂ (M=Ni, Cu; where Ni=nickel, Cu=copper).

3. The positive electrode additive of claim 1, wherein the coating layer ranges from 1 to 10 wt % based on 100 wt % of the additive core.

4. A method of manufacturing a positive electrode additive for a lithium secondary battery, which is used to manufacture a positive electrode for a lithium secondary battery, the method comprising:
a core preparation operation of preparing a lithium (Li)-based additive core;
a coating solution preparation operation of preparing a coating solution to form a coating layer composed of NbO_{X}C_{y} (0≤x≤2.5 and 0≤y≤1; where Nb=niobium, O=oxygen, C=carbon); and
a coating operation of coating a surface of the additive core with the coating solution and forming a coating layer.

5. The method of claim 4, wherein, in the core preparation operation, lithium dioxide (Li₂O) is reacted with a MO precursor (M=Ni, Cu) to prepare a powdered additive core of Li₂MO₂ (M=Ni, Cu; where Ni=nickel, Cu=copper).

6. The method of claim 5, wherein the core preparation operation includes:
a core pelletization process of mixing and pelletizing Li₂O and the MO precursors (M=Ni, Cu); and
a core sintering process of heating and sintering the pelletized core material in an inert atmosphere to obtain the additive core.

7. The method of claim 4, wherein, in the coating solution preparation operation, the coating solution is prepared by dispersing niobium ethoxide (Nb(OC₂H₅)₅) and urea (CH₄N₂O) at the same molar ratio in a solvent.

8. The method of claim 7, wherein the coating operation includes:
a dispersion operation of dispersing the additive core in the prepared coating solution;
a reaction operation of generating a reactant forming the coating layer on the surface of the additive core by stirring and reacting the additive core dispersed in the solvent with Nb(OC₂H₅)₅ and CH₄N₂O;
a drying operation of drying the solvent in which the reactant is generated in an inert atmosphere; and
a sintering operation of sintering the dried reactant and producing an additive in the form of a powder.

9. The method of claim 8, wherein, in the reaction operation, the additive core dispersed in the solvent, Nb(OC₂H₅)₅, and CH₄N₂O are stirred ranging from 300 to 400 revolutions-per-minute (rpm) for ap period of time ranging from 1 to 2 hours at room temperature, and the solvent is evaporated while reacting with Nb(OC₂H₅)₅ and CH₄N₂O on the surface of the additive core.

10. The method of claim 8, wherein, in the drying operation, the additive core having the reactant formed on the surface thereof is dried at a temperature ranging from 110 to 130° C. for a period of time ranging from 11 to 13 hours in a vacuum oven.

11. The method of claim 8, wherein, in the sintering operation, the coating layer is formed on the surface of the additive core by performing heat treatment on the additive core having the reactant generated on the surface thereof at a temperature ranging from 250 to 350° C. for a period of time ranging from 3 to 5 hours in a sintering furnace in an argon (Ar) atmosphere.

12. A positive electrode for a lithium secondary battery, the positive electrode including a positive electrode additive comprising:
a lithium (Li)-based additive core; and
a coating layer of NbO_{X}C_{y} (0≤x≤2.5 and 0≤y≤1; where Nb=niobium, O=oxygen, C=carbon) formed on a surface of the additive core.

13. The positive electrode of claim 12, further comprising:
a conductive material and a binder.

14. A lithium secondary battery comprising the positive electrode according to claim 12.

15. The lithium secondary battery of claim 14, further comprising:
a negative electrode including a negative electrode active material; and
an electrolyte.
